(19) United States
(12) Patent Application Publication
(10) Pub. No.: US 2005/0231448 A1
(43) Pub. Date: Oct. 20, 2005

(54) Organic EL display apparatus

(76) Inventors: Hisao Tanabe, Tokyo (JP); Naoki Kobayashi, Tokyo (JP); Yasushi Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/109,713

(22) Filed: Apr. 20, 2005

(30) Foreign Application Priority Data
Apr. 20, 2004 (JP) P2004-124611

(51) Int. Cl. G09G 3/30

(52) U.S. Cl. 345/76

(57) ABSTRACT

Disclosed is an organic EL display comprising a light emitting section; a current control section which controls a current to be flown to the light emitting section; a first switching section which switches between transmission and non-transmission of the current controlled; a current detection section which detects the controlled current transmitted; a comparison amplifying section which performs comparison and amplification of a voltage value corresponding to the detected current and a voltage value corresponding to the image signal; a second switching section which switches between transmission and non-transmission of the voltage value resulting from the comparison and amplification; and an image signal holding capacitor which is charged or discharged according to the voltage value transmitted from the second switching section, wherein the current control section controls the current to be flown to the light emitting section according to the charging voltage of the image signal holding capacitor.

### BACKGROUND

1. Field of the Invention

The present invention relates to an organic EL (electroluminescence) display apparatus in which a self-emission organic EL element is used for each pixel and disposed in a matrix form, and more particularly to an organic EL display apparatus which is suitable for reduction of luminance variation of the individual pixels.

2. Description of the Related Art

The display apparatus using the organic EL elements has features not possessed by an LCD (liquid crystal display) because the organic EL elements are self-emission elements not requiring a backlight and appropriate for reduction of power consumption. It also has characteristics including a quick response and a wide viewing angle, and the element itself is solid, so that it has an advantage that it can be applied to flexible usage.

To drive the organic EL display apparatus, PM (passive matrix) drive and AM (active matrix) drive can be employed in the same manner as the LCD, but the AM drive method, which provides the individual pixels with a thin-film transistor (TFT) to separately control them, is the mainstream. Thus, the provision of high definition, long life and lower power consumption is also taken into consideration.

To control the emission of light by each pixel of the organic EL display apparatus without involving variation, it is necessary to provide the same current value to the individual pixels for a prescribed image signal. Especially, such control is important for a method that the image signal is given as an analog signal and the pixels are caused to emit an intermediate light according to its analog value. Based on the above premise, examples of an organic EL display apparatus, which is intended to reduce luminance variation, include one described in the following patent document 1.

[Patent Document 1] Japanese Patent Laid-Open Application No. 2002-91377

For the display apparatus disclosed in the above literature, there is used a structure of making negative feedback such that the pixel current corresponds to the image signal. Thus, even if a current control circuit has variations in an input voltage vs. output current characteristic, such variations are absorbed, and the pixels are provided with the same current value with respect to a prescribed image signal. But, it might have a disadvantage in view of an aperture ratio (a ratio of the net area of the light emitting section to the display area) of the display because it is essentially necessary to form an error amplifying circuit, which is required for negative feedback, on the individual pixels.

### SUMMARY

Under the circumstances described above, the present invention provides an organic EL display apparatus in which a self-emission organic EL element is used for each pixel and disposed in a matrix form, which reduces luminance variation of each pixel and can reduce the lowering of the aperture ratio to a small level.

According to an aspect of the present invention, there is provided an organic EL display apparatus which has plural pixels arranged in a matrix form, selects pixels from the plural pixels according to a pixel selection signal and causes the selected pixels to emit light according to an image signal, comprising a light emitting section; a current control section which controls a current to be flown to the light emitting section; a first switching section which switches between transmission and non-transmission of the current controlled by the current control section according to the pixel selection signal; a current detection section which detects the value of the controlled current transmitted by the first switching section as a voltage; a comparison amplifying section which performs comparison and amplification of a voltage value corresponding to the detected current and a voltage value corresponding to the image signal; a second switching section which switches between transmission and non-transmission of the voltage value resulting from the comparison and amplification according to the pixel selection signal; and an image signal holding capacitor which is charged or discharged according to the voltage value transmitted from the second switching section, wherein the current control section controls the current to be flown to the light emitting section according to the charging voltage of the image signal holding capacitor.

By configuring as described above, the image signal is input to one input end of the comparison amplifying section, while a voltage is given to the other input from the current detection section which detects the current transmitted by the first switching section. And, the output of the comparison amplifying section is supplied to the image signal holding capacitor and the current control section via the second switching section. In this structure, it is easy to achieve the use of the first switching section of the individual pixels for the multiplexer and the second switching section of the individual pixels for the demultiplexer. In other words, one set of the comparison amplifying section and the current detection section is enough for the plural pixels, so that it is not necessary to dispose the comparison amplifying section and the current detection section for each of the pixels. Thus, the cause of lowering the aperture ratio can be eliminated. And, the negative feedback is made by the comparison amplifying section. Therefore, even if the input voltage vs. output current characteristic of the current control section is variable, it is absorbed, and the same current value can be obtained for the pixels with respect to a prescribed image signal.

According to the organic EL display apparatus of the present invention, it has for the negative feedback the current detection section and the comparison amplifying section but does not need the provision of the current detection section and the comparison amplifying section for the individual pixels. Thus, it reduces luminance variation of each pixel and can reduce the lowering of the aperture ratio to a small level.

### BRIEF DESCRIPTION OF THE DRAWINGS

FIG. 1 is a block view showing a structure of a particular pixel of an organic EL display apparatus according to one embodiment of the present invention.

FIG. 2 is a circuit diagram showing an example of applying a specific element to the individual blocks in the embodiment shown as the block view in FIG. 1.

FIG. 3 is a circuit diagram different from the structure shown in FIG. 2 and showing an example of applying specific elements to the individual blocks in the embodiment shown as the block view in FIG. 1.

FIG. 4 is a block view showing a structure of a particular pixel in an organic EL display apparatus according to another embodiment of the present invention.

FIG. 5 is a circuit diagram showing an example of applying a specific element to the individual blocks in the embodiment shown as the block view in FIG. 4.

FIG. 6 is a block view showing a structure of a particular pixel in an organic EL display apparatus according to still another embodiment of the present invention.

FIG. 7 is a circuit diagram showing an example of applying a specific element to the individual blocks in the embodiment shown as the block view in FIG. 6.

FIG. 8 is a view showing connections between a power line 1, an image signal line 2 and a scanning line 3 and the individual pixels with the pixels having the structure shown in FIG. 1 used and disposed longitudinally and latitudinally.

FIG. 9 is a block view showing a structure of a particular pixel in an organic EL display apparatus according to yet another embodiment of the present invention.

FIG. 10 is a circuit diagram showing an example of applying a specific element to the individual blocks in the embodiment shown as the block view in FIG. 9.

FIG. 11 is a block view showing a structure of a particular pixel in the organic EL display apparatus according to yet another embodiment of the present invention.

FIG. 12 is a circuit diagram showing an example of applying a specific element to the individual blocks in the embodiment shown as the block view in FIG. 11.

FIG. 13 is a block view showing a structure of a particular pixel in an organic EL display apparatus according to yet another embodiment of the present invention.

FIG. 14 is a circuit diagram showing an example of applying a specific element to the individual blocks in the embodiment shown as the block view in FIG. 13.

FIG. 15 is a view showing connections between the power line 1, the image signal line 2 and the scanning line 3 and the individual pixels with the pixels having the structure shown in FIG. 9 used and disposed longitudinally and latitudinally.

FIG. 16 is a block view showing a structure of a particular pixel in an organic EL display apparatus according to yet another embodiment of the present invention.

FIG. 17 is a circuit diagram showing an example of applying a specific element to the individual blocks in the embodiment shown as the block view in FIG. 16.

FIG. 18 is a block view showing a structure of a particular pixel in an organic EL display apparatus according to yet another embodiment of the present invention.

FIG. 19 is a circuit diagram showing an example of applying a specific element to the individual blocks in the embodiment shown as the block view in FIG. 18.

FIG. 20 is a block view showing a structure of a particular pixel in an organic EL display apparatus according to yet another embodiment of the present invention.

FIG. 21 is a circuit diagram showing an example of applying a specific element to the individual blocks in the embodiment shown as the block view in FIG. 20.

FIG. 22 is a view showing connections between the power line 1, the image signal line 2 and the scanning line 3 and the individual pixels with the pixels having the structure shown in FIG. 16 used and disposed longitudinally and latitudinally.

FIG. 23 is a block view showing a structure of a particular pixel in an organic EL display apparatus according to yet another embodiment of the present invention.

FIG. 24 is a circuit diagram showing an example of applying a specific element to the individual blocks in the embodiment shown as the block view in FIG. 23.

FIG. 25 is a block view showing a structure of a particular pixel in an organic EL display apparatus according to yet another embodiment of the present invention.

FIG. 26 is a circuit diagram showing an example of applying a specific element to the individual blocks in the embodiment shown as the block view in FIG. 25.

FIG. 27 is a block view showing a structure of a particular pixel in an organic EL display apparatus according to yet another embodiment of the present invention.

FIG. 28 is a circuit diagram showing an example of applying a specific element to the individual blocks in the embodiment shown as the block view in FIG. 27.

FIG. 29 is a view showing connections between the power line 1, the image signal line 2 and the scanning line 3 and the individual pixels with the pixels having the structure shown in FIG. 23 used and disposed longitudinally and latitudinally.

FIG. 30A and FIG. 30B are equivalent circuit diagrams each showing a structure of a pixel of an organic EL display apparatus as a comparative example.

### DETAILED DESCRIPTION

(Description of Examples)

Embodiments of the present invention will be described with reference to the drawings, which are provided for illustration only and do not limit the present invention in any respect.

As a form of an embodiment of the present invention, it can be determined that the current detection section is a resistor or a Hall element which is inserted and connected between a power source and the first switching section, and the light emitting section is inserted and connected between the current control section and a ground. A resistor or a Hall element which has an easy formation as a current detection section is used. In addition, the light emitting section is formed with a ground as reference.

Here, the current detection section may detect as voltage the value of the controlled current using an on resistance of the thin film transistor which is inserted and connected between the power source and the first switching section. Thus, it is not necessary to incorporate the resistor and it is advantageous in view of the production process.

Here, the current control section is an n channel thin film transistor and can be configured such that the current to be flown to the light emitting section is output as the drain-source current, and the current control is effected by a charging voltage of the image signal holding capacitor supplied to the gate. It is a configuration when the n channel thin film transistor is used for the current control section.

Besides, the current control section is a p channel thin film transistor and can also be configured such that the current to be flown to the light emitting section is output as the source-drain current, and the current control is effected by the charging voltage of the image signal holding capacitor supplied to the gate. It is a configuration when the p channel thin film transistor is used for the current control section.

As a form of an embodiment, it can be determined that the current detection section is a resistor or a Hall element which is inserted and connected between a ground and the first switching section, and the light emitting section is inserted and connected between the current control section and the power source. The resistor or the Hall element having an easy formation is used as the current detection section, and the light emitting section is configured with the power source as reference.

Here, the current control section is also an n channel thin film transistor and can be configured such that the current to be flown to the light emitting section is output as drain-source current, and the current control is effected by the charging voltage of the image signal holding capacitor supplied to the gate.

In addition, a form of an embodiment can be configured such that the light emitting section, the current control section, the first switching section, the second switching section and the image signal holding capacitor are provided for each of the plural pixels, one set of the comparison amplifying section and the current detection section is disposed for each column of pixels in the matrix form, the connection from the first switching section to the current detection section is made from all the pixels contained in the column of pixels to which the current detection section belongs, and the connection from the comparison amplifying section to the second switching section is made on all the pixels contained in the column of pixels to which the comparison amplifying section belongs. It is a configuration that the use of the above-described first and second switching sections as multiplexer or demultiplexer is integrated for each column of pixels in the matrix form. Thus, the provision of one set of the current detection section and the comparison amplifying section for each column is sufficient, and the number of the current detection section and the comparison amplifying section to be incorporated can be minimized.

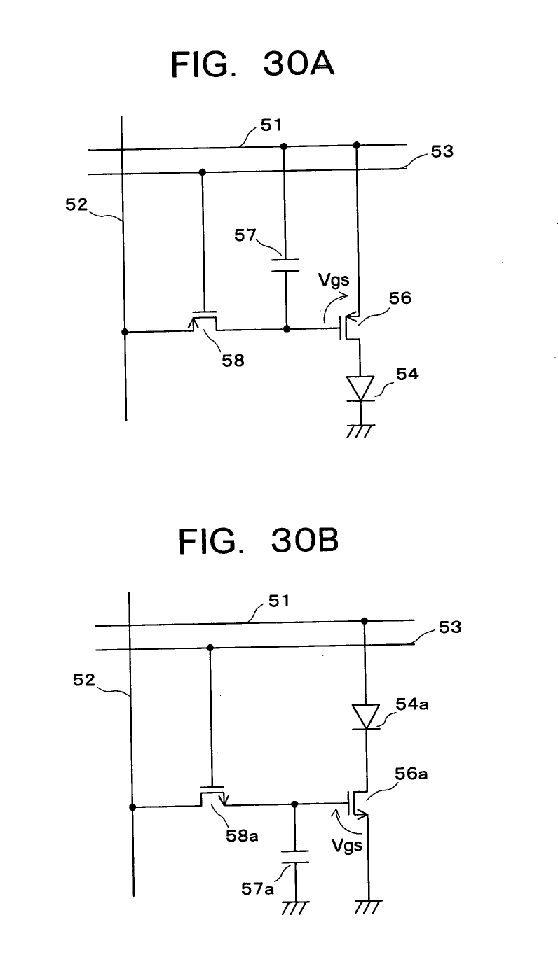

Under the circumstances described above, embodiments of the present invention will be described below with reference to the drawings. First, prior to the explanation of the embodiments, a cause of the generation of uneven luminance in the individual pixels of the organic EL display apparatus will be described with reference to FIG. 30A and FIG. 30B. FIG. 30A and FIG. 30B are equivalent circuit diagrams each showing a structure of each pixel of the organic EL display apparatus as comparative examples. FIG. 30A shows a structure using p channel transistors 56, 58 as thin-film transistors (TFTs), and FIG. 30B shows a structure using n channel transistors 56a, 58a as thin-film transistors.

It is shown in FIG. 30A that an organic EL element 54 as a light emitting section is formed with a ground as reference, while it is shown in FIG. 30B that an organic EL element 54a is formed with a power source as reference. Reference numerals 57, 57a denote image signal holding capacitors, reference numeral 51 denotes a power line, reference numeral 52 denotes an image signal line, and reference numeral 53 denotes a scanning line. It is not shown but the image signal line 52 is commonly connected to other pixels in a longitudinal (column) direction, and the scanning line 53 is commonly connected to other pixels in a latitudinal (row) direction.

To the image signal line 52 is supplied an image signal with an analog value (voltage), and a pixel selection signal is synchronously supplied to the scanning line 53. When the pixel selection signal is supplied to the scanning line 53, the transistor 58 (58a) is brought into a conductive state, and the image signal holding capacitor 57 (57a) is charged or discharged according to the voltage of the image signal on the image signal line 52. The capacitor 57 (57a) keeps that voltage until the transistor 58 (58a) is brought into a conductive state next time. The transistor 56 (56a) controls the drain current by the voltage held by the capacitor 57 (57a).

Here, an input voltage (source-to-gate voltage Vgs) vs. output current (drain current Ids, particularly a source-drain current for the p channel transistor 56 considering a current direction, and also a drain-source current for the n channel transistor 56a) characteristic of the transistor 56 (56a) is represented by the following expression. Specifically, it is Ids=(½)·μ·Cox·(W/L)·(Vgs−Vth)². Here, μ denotes a carrier mobility, Cox denotes a gate capacitance per unit area, W denotes a channel width, L denotes a channel length, and Vth denotes a threshold voltage. It is apparent from the expression that if the threshold voltage Vth is variable depending on the individual pixels, the output current (drain current Ids) with respect to the same input voltage (source-to-gate voltage Vgs) is variable because of a square characteristic (namely, very high sensitivity). The drain current Ids is a current to be flown as it is to the organic EL element 54 (54a), causing current variations, namely luminance variations.

For the TFT as the transistor 56 (56a), polysilicon having remarkable current drive ability is often used as its channel material, but as a characteristic of the element, the threshold voltage Vth varies actually by, for example, about a few tens of mV. Therefore, the structures of these comparative examples cannot avoid luminance variations of each of the pixels as the display apparatus. In addition, when it is designed to reduce the center value of Vth in order to reduce the variations of the drain current Ids, the drain current Ids becomes large, and the power consumption of the organic EL display apparatus cannot be reduced. Thus, it is not desirable.

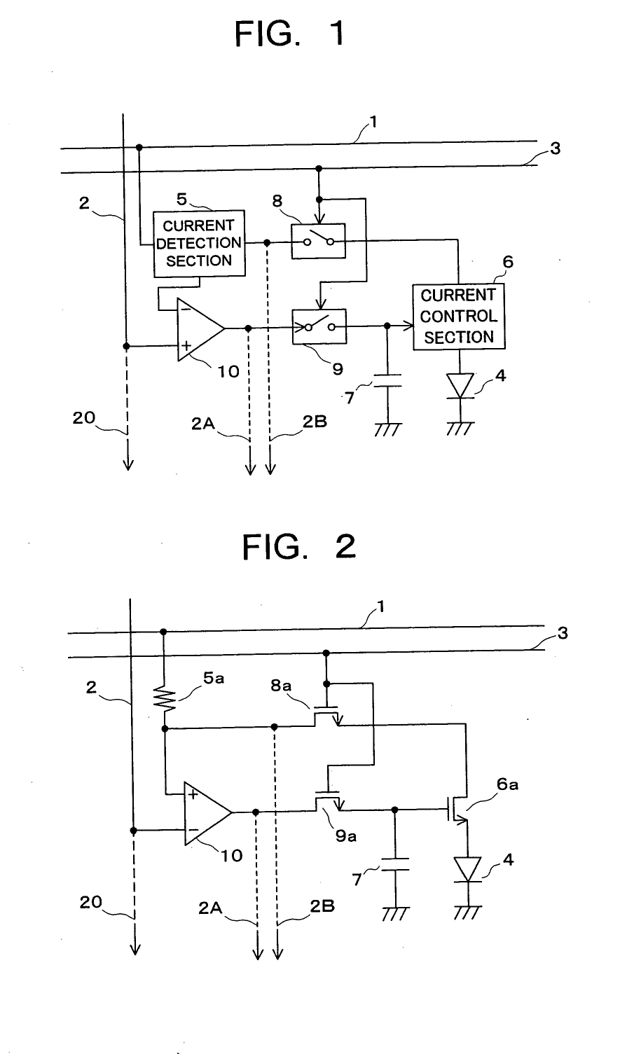

Meanwhile, FIG. 1 is a block view showing a structure of a prescribed pixel of the organic EL display apparatus according to one embodiment of the present invention. As shown in FIG. 1, to this pixel are connected a power line 1, an image signal line 2 and a scanning line 3. This pixel has a light emitting section 4, a current detection section 5, a current control section 6, an image signal holding capacitor 7, a first switching section 8, a second switching section 9 and a comparison amplifying section 10. It is not shown in the drawing but the scanning line 3 is commonly connected to other pixels in a latitudinal (row) direction.

The light emitting section 4 is an organic EL element which is formed with a ground as reference, and its anode side is connected to the current output terminal of the current control section 6. The current control section 6 controls the current flowing from the current detection section 5 to the light emitting section 4 via the first switching section 8, and the control input terminal of the current control section 6 is connected to one end of the capacitor 7 such that its control complies with the voltage being held by the voltage holding capacitor 7.

The first switching section 8 is disposed between the current control section 6 and the current detection section 5, and according to a pixel selection signal through the scanning line 3 performs switching of transmission/non-transmission of the current flown to the current detection section 5 by the current control section 6. The current detection section 5 is connected between the power line 1 and the first switching section 8, and via the first switching section 8 detects the current as a result of controlling by the current control section 6. The detected current is guided as a voltage value to the inverting input terminal of the comparison amplifying section 10. The second switching section 9 is disposed between the output of the comparison amplifying section 10, and one end of the image signal holding capacitor 7 and the control input terminal of the current control section 6. The second switching section 9 performs switching of transmission/non-transmission according to the pixel selection signal from the scanning line 3 and guides the output voltage from the comparison amplifying section 10 to one end of the image signal holding capacitor 7 and the control input terminal of the current control section 6 at the time of transmitting.

The comparison amplifying section 10 has a function of subtracting the voltage of the inverting input terminal from the voltage of the non-inverting input terminal and amplifying the result with a large gain to output. The inverting input terminal and the output are connected to the current detection section 5 or the second switching section 9 as described above, and the image signal is supplied from the image signal line 2 to its non-inverting input terminal. A broken line 2B which is drawn to extend from the first switching section 8, a broken line 2A which is drawn to extend from the output of the comparison amplifier 10 and a long broken line 20 which is drawn to extend from the image signal line 2 will be described later.

According to the pixel of the organic EL display apparatus configured as shown in FIG. 1, when an image signal is given to the image signal line 2, a pixel selection signal is given to the scanning line 3, and the first and second switching sections 8, 9 are closed, a voltage substantially equal to the image signal becomes the output voltage of the current detection section 5. It is because a negative feedback path is formed of a loop of the current detection section 5, the comparison amplifying section 10, the second switching section 9, the current control section 6, the first switching section 8 and the current detection section 5, and a relationship between the non-inverting input and the inverting input of the comparison amplifying section 10 becomes a so-called imaginary short state.

Thus, the current of the current detection section 5 has a value corresponding to the image signal given to the image signal line 2, and the agreed current flows to the light emitting section 4 via the first switching section 8 and the current control section 6. Therefore, variations in the current flowing through the light emitting section 4 is eliminated in principle. Thus, luminance variation of each pixel is eliminated. In other words, a voltage which makes the current value of the light emitting section 4 constant is generated in the image signal holding capacitor 7 by the above-described negative feedback path regardless of variations in the input voltage vs. output current characteristic of the current control section 6.

As a display apparatus, the easiest structure has the pixels with the above-described configuration arranged in longitudinal (column) and latitudinal (row) directions. In this case, the image signal line 2 is extended as indicated by the long broken line 20 so as to be commonly connected to other pixels in the londitudinal (column) direction. A conducting wire corresponding to the broken lines 2A, 2B is not disposed. But, it is disadvantageous in terms of the aperture ratio (a ratio of the net area of the light emitting section to the display area) because it is necessary to dispose and incorporate the current detection section 5 and the comparison amplifying section 10 in addition to the first and second switching sections 8, 9 for each of the pixels.

Therefore, a structure not requiring disposing the current detection section 5 and the comparison amplifying section 10 on the individual pixels can also be conceived. The broken line 2B which is drawn to extend from the first switching section 8 and the broken line 2A which is drawn to extend from the output of the comparison amplifier 10 are disposed as the conducting wires, and these conductive wires are commonly connected to the individual pixels in the column direction. A conducting wire corresponding to the long broken line 20 is not disposed. Unshown individual pixels, to which the broken lines 2B, 2A are connected, are not provided with the current detection section 5 and the comparison amplifying section 10.

According to such a structure, the first switching section 8 becomes a multiplexer which selects the control current by the current control section 6 of the individual pixels in the column direction, and the second switching section 9 becomes a demultiplexer which distributes the output of the comparison amplifying section 10 to the image signal holding capacitor 7 of the individual pixels in the column direction. Such selection and distribution are performed according to the pixel selection signal given to the scanning line 3. By configuring as described above, the current detection section 5 and the comparison amplifier 10 are sufficient when disposed in at least one pair each for the individual columns, and necessity of incorporation on the display surface of the display apparatus can be eliminated, so that a large effect of increasing the aperture ratio can be obtained. A structure in that each pair of them is not disposed on the individual columns but disposed on each of a plurality of rows of the individual columns can also be adopted.

FIG. 2 is a circuit diagram showing an example of applying a specific element to the individual blocks in the embodiment shown as the block view in FIG. 1. In FIG. 2, the same reference numerals are allotted to the same component parts as those shown in FIG. 1. In this case, a resistor 5a is used as the current detection section 5, and n channel transistors 6a, 8a, 9a are used as the current control section 6, the first switching section 8 and the second switching section 9, respectively. The transistors 6a, 8a, 9a can be thin-film MOS transistors formed on the glass substrate as known well. Among them, the thin-film MOS transistor can be a so-called amorphous silicon transistor. In the circuit of FIG. 2, the detection polarity of the resistor 5a as the current detection section is reversed, so that the input terminal of the comparison amplifying section 10 is made opposite to that shown in FIG. 1.

The connection of the n channel transistors 6a, 8a, 9a is additionally described below. The transistor 6a has a source connected to the anode of the light emitting section 4 and a drain connected to the source of the transistor 8a. A gate is connected to one end of the image signal holding capacitor 7. The transistor 8a has a gate connected to the scanning line 3, a drain connected to one end of the resistor 5a and a source connected to the drain of the transistor 6a. The transistor 9a has a gate connected to the scanning line 3, a drain connected to the output of the comparison amplifying section 10 and the source connected to one end of the image signal holding capacitor 7. The transistor 9a can have the source and the drain reversed because it performs a switching operation substantially by voltage.

In this structure example, the resistor 5a is used as the current detection section 5 and the voltage value can be detected easily in proportion to the current flowing through it. In addition, there is also an advantage in view of the process by simplification of the formation because incorporation of the resistor 5a into each pixel can be avoided. At this time, variations in the current value of each pixel after controlling due to variations in the resistance value can be prevented in principle. If necessary, the resistor 5a may be externally attached independent of the substrate on which the pixels are formed. In this connection, for example, a Hall element can be used instead of the resistor 5a.

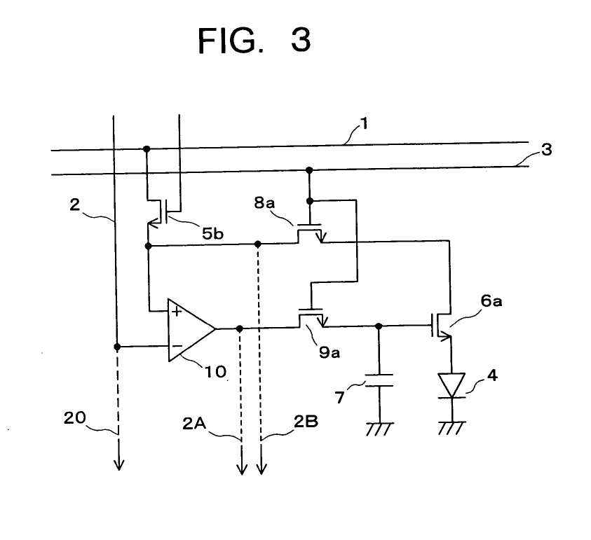

FIG. 3 is a circuit diagram different from the structure shown in FIG. 2 and showing an example of applying specific elements to the individual blocks in the embodiment shown as the block view in FIG. 1. In FIG. 3, the same reference numerals are allotted to the same component parts as those shown in the above-described drawings, and the description on them is omitted.

In this structure example, an on resistance of the n channel transistor 5b is used as the current detection section 5. Therefore, in FIG. 3, the drain of the transistor 5b is connected to the power line 3, the source is connected to the drain of the transistor 8a and to the non-inverting input terminal of the comparison amplifying section 10, and the gate is connected to an unshown voltage supply. By configuring in this way, the necessity of incorporation of the resistor 5a as in the structure shown in FIG. 2 is eliminated, and the structure can be made of substantially the n channel transistor only. Therefore, the production process of the organic EL display apparatus can be simplified, providing an advantage in the production cost and the like. Besides, variations in the current value of each pixel after controlling due to the variations in the resistance value can also be prevented in principle.

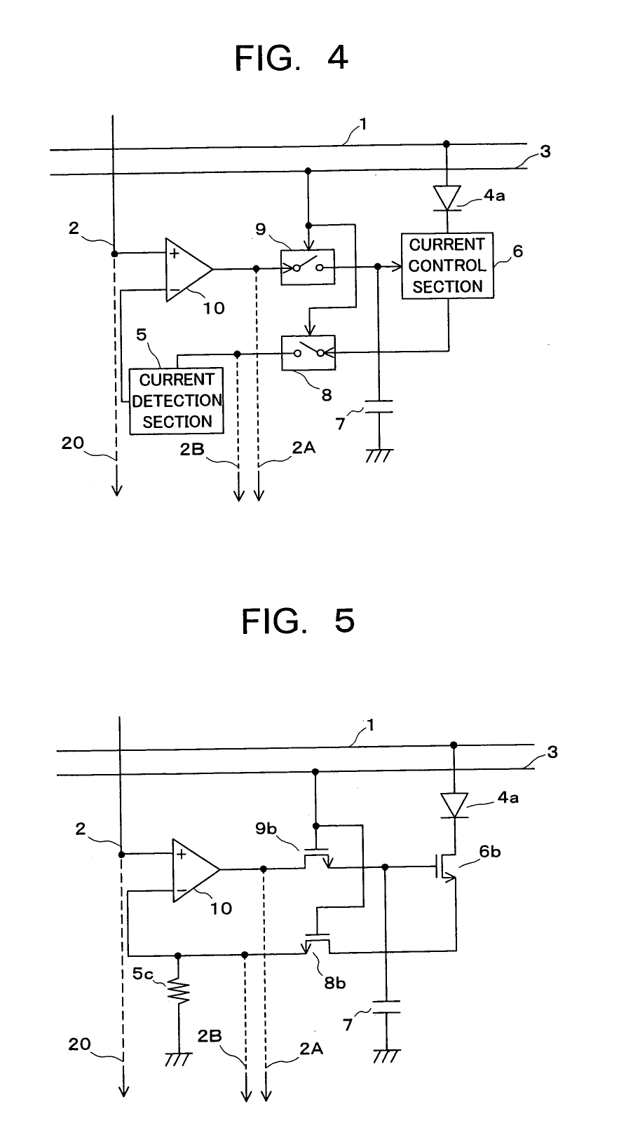

FIG. 4 is a block view showing a structure of a particular pixel in the organic EL display apparatus according to another embodiment of the present invention. In FIG. 4, the same reference numerals are allotted to the same component parts as those described above, and the description on them is omitted. In this embodiment, an organic EL element which is formed with a power source as reference is used as the light emitting section 4a. Thus, the current flown to the light emitting section 4a has a current passage formed of the light emitting section 4a, the current control section 6, the first switching section 8 and the current detection section 5.

In this structure, a negative feedback path is also formed of a loop of the current detection section 5, the comparison amplifying section 10, the second switching section 9, the current control section 6, the first switching section 8 and the current detection section 5, and a voltage almost equal to the image signal given to the image signal line 2 becomes an output voltage of the current detection section 5. Thus, the current in the current detection section 5 has a value matching the image signal given to the image signal line 2, and the matched current flows to the light emitting section 4a via the first switching section 8 and the current control section 6. Therefore, variations in the current flowing to the light emitting section 4a are eliminated in principle. Thus, the luminance variation of each pixel is eliminated.

FIG. 5 is a circuit diagram showing an example of applying a specific element to the individual blocks in the embodiment shown as the block view in FIG. 4. In FIG. 5, the same reference numerals are allotted to the same component parts as those shown in FIG. 4. In this case, a resistor 5c is used as the current detection section 5, and n channel transistors 6b, 8b, 9b are used as the current control section 6, the first switching section 8 and the second switching section 9, respectively. The transistors 6b, 8b, 9b can be thin-film MOS transistors formed on the glass substrate as known well. The transistors 6b, 8b, 9b can also be amorphous silicon transistors in the same manner as the transistors 6a, 8a, 9a (FIG. 2 and the like).

The connection of the n channel transistors 6b, 8b, 9b is additionally described below. The transistor 6b has a drain connected to the cathode of the light emitting section 4a and a source connected to a drain of the transistor 8b. A gate is connected to one end of the image signal holding capacitor 7. The transistor 8b has a gate connected to the scanning line 3, the drain connected to the source of the transistor 6b, and a source connected to the inverting input terminal of the comparison amplifying section 10. The transistor 9b has a gate connected to the scanning line 3, a drain connected to the output of the comparison amplifying section 10, and a source connected to one end of the image signal holding capacitor 7. The transistor 9b can have the source and the drain reversed because it performs a switching operation substantially by voltage.

In this structure example, the resistor 5c is used as the current detection section 5 in the same manner as in the structure example shown in FIG. 2 and the voltage value can be obtained easily in proportion to the current flowing through it. There is also an advantage in view of the process by simplification of the formation because incorporation of the resistor 5c into each pixel can be avoided. At this time, variations in the current value of each pixel after controlling due to variations in the resistance value can be prevented in principle. If necessary, the resistor 5c may be externally attached independent of the substrate on which the pixels are formed. In this connection, for example, a Hall element can be used instead of the resistor 5c.

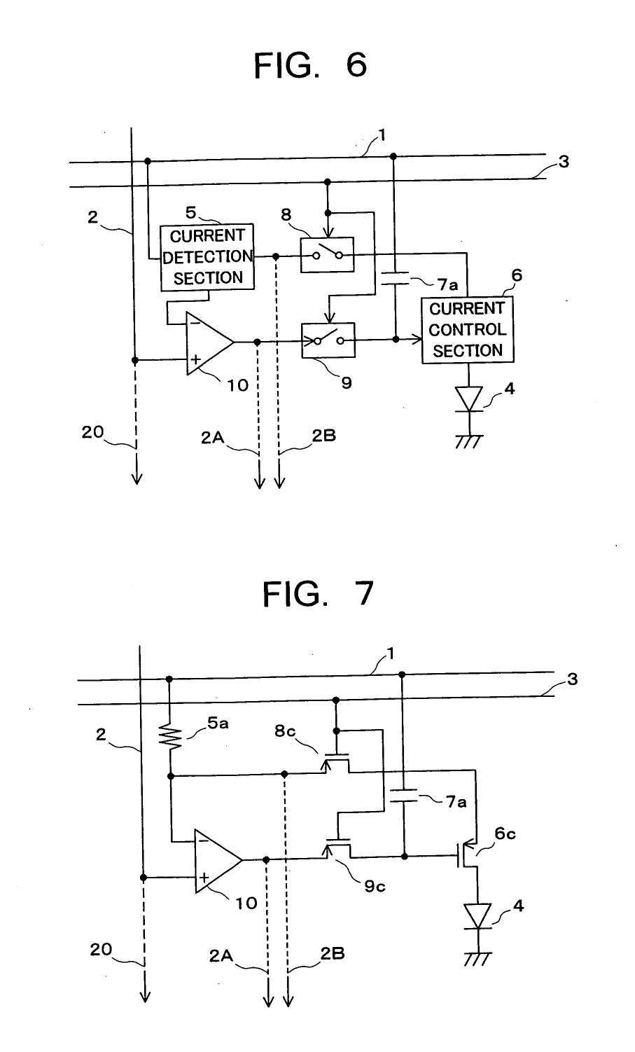

FIG. 6 is a block view showing a structure of a particular pixel in the organic EL display apparatus according to still another embodiment of the present invention. In FIG. 6, the same reference numerals are allotted to the same component parts as those described above, and the description on them is omitted. In this embodiment, which is different from the embodiment shown in FIG. 1, the other end of the image signal holding capacitor 7a is not connected to the ground but to the power line 1. This difference between the capacitor 7 and the capacitor 7a does not cause an operational difference in the pixels.

FIG. 7 is a circuit diagram showing an example of applying a specific element to the individual blocks in the embodiment shown as the block view in FIG. 6. In FIG. 7, the same reference numerals are allotted to the same component parts as those shown in FIG. 6. In this case, a resistor 5a is used as the current detection section 5, and p channel transistors 6c, 8c, 9c are used as the current control section 6, the first switching section 8 and the second switching section 9, respectively. The transistors 6c, 8c, 9c can be thin-film MOS transistors formed on the glass substrate as known well. Among them, the transistors 6c, 8c, 9c can also be amorphous silicon transistors.

The connection of the p channel transistors 6c, 8c, 9c is additionally described below. The transistor 6c has a drain connected to the anode of the light emitting section 4 and a source connected to a drain of the transistor 8c. A gate is connected to one end of the image signal holding capacitor 7a. The transistor 8c has a gate connected to the scanning line 3, a source connected to one end of the resistor 5a and the drain connected to the source of the transistor 6c. The transistor 9c has a gate connected to the scanning line 3, a source connected to the output of the comparison amplifying section 10 and the drain connected to one end of the image signal holding capacitor 7a. The transistor 9c can have the source and the drain reversed because it performs a switching operation substantially by voltage.

In this structure example, the resistor 5a is used as the current detection section 5 in the same manner as in the structure examples shown in FIG. 2 and FIG. 5 and the voltage value can be obtained easily in proportion to the current flowing through it. There is also an advantage in view of the process by simplification of the formation because incorporation of the resistor 5a into each pixel can be avoided. At this time, variations in the current value of each pixel after controlling due to variations in the resistance value can be prevented in principle. If necessary, the resistor 5a may be externally attached independent of the substrate on which the pixels are formed. In this connection, for example, a Hall element can be used instead of the resistor 5a. In this structure example, the detection polarity of the resistor 5a as the current detection section is not reversed, so that the input terminal of the comparison amplifying section 10 is the same as that shown in FIG. 6.

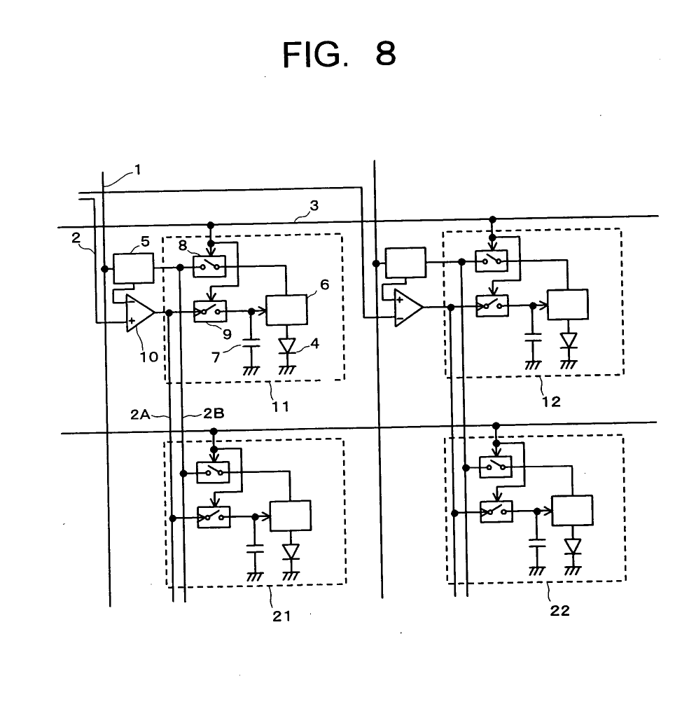

FIG. 8 is a repetition of what is described above and a view showing the connection between the power line 1, the image signal line 2 and the scanning line 3 and the individual pixels with the pixels having the structure shown in FIG. 1 used and disposed longitudinally and latitudinally. In FIG. 8, the same reference numerals are allotted to the same component parts as those described above. As shown in FIG. 8, pixels 11, 12, . . . are disposed in a latitudinal (row) direction and the pixels 11, 21, . . . are disposed in a longitudinal (column) direction so that the pixels are arranged in a matrix form as a whole. It is easily apparent from the drawing that the current detection section 5 and the comparison amplifying section 10 are not required for each of the pixels.

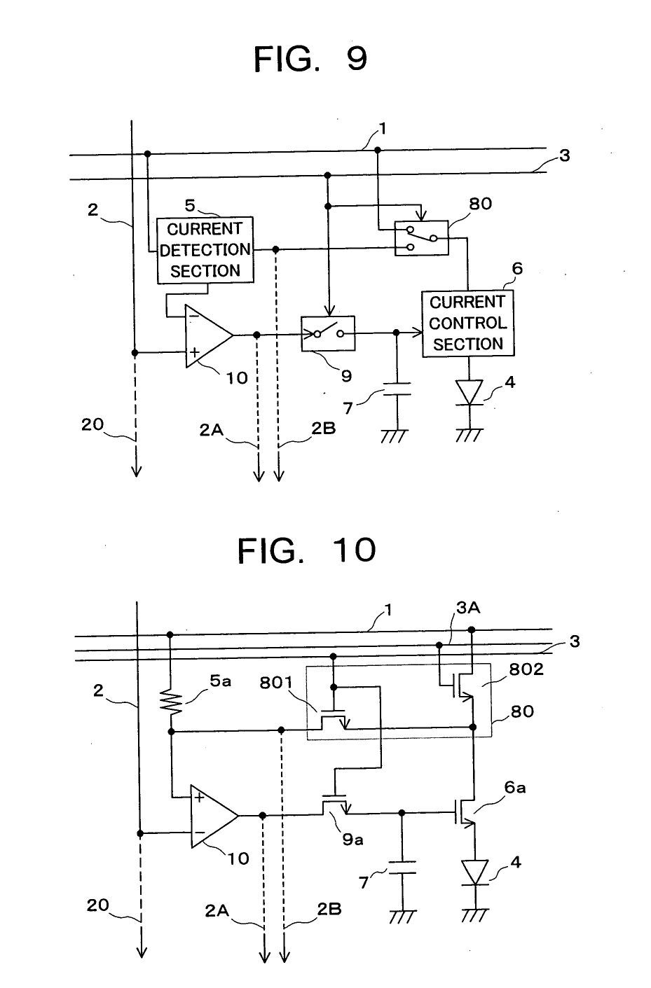

FIG. 9 is a block view showing a structure of a particular pixel in the organic EL display apparatus according to yet another embodiment of the present invention. In FIG. 9, the same reference numerals are allotted to the same component parts as those described above, and the description on them is omitted. In this embodiment, a first switching section 80 which has substantially the same function as the first switching section 8 shown in FIG. 1 is used instead of the first switching section 8.

The first switching section 80 is the same as the first switching section 8 of FIG. 1 in view of a function of switching of transmission/non-transmission between the current control section 6 and the current detection section 5. A difference is that the current input terminal of the current control section 6 is brought into a state to be connected to the power line 1 when the current control section 6 and the current detection section 5 are mutually brought into a non-transmission state. Thus, the current control section 6 can continue to flow a current regardless of the switching position of the first switching section 80 and can stably keep the light emission by the light emitting section 4 until the next scanning by the scanning line 3.

FIG. 10 is a circuit diagram showing an example of applying a specific element to the individual blocks in the embodiment shown as the block view in FIG. 9. In FIG. 10, the same reference numerals are allotted to the same component parts as those of FIG. 9, and the description on them is omitted. As shown in FIG. 10, a switch circuit comprising two n channel transistors 801, 802 is used as the first switching section 80. The n channel transistor 801 has completely the same connection and function as the n channel transistor 8a shown in FIG. 2.

The n channel transistor 802 has a drain connected to the power line 1, a source connected to the drain of the n channel transistor 6a which is the current control section, and a gate connected to a second scanning line 3A having a polarity opposite to that of the scanning line 3. By configuring in this way, one of the transistor 801 and the transistor 802 is turned on and the other is turned off by the scan signal (image selection signal) supplied to the scanning lines 3, 3A, so that the function of the first switching section 80 shown in FIG. 9 can be realized.

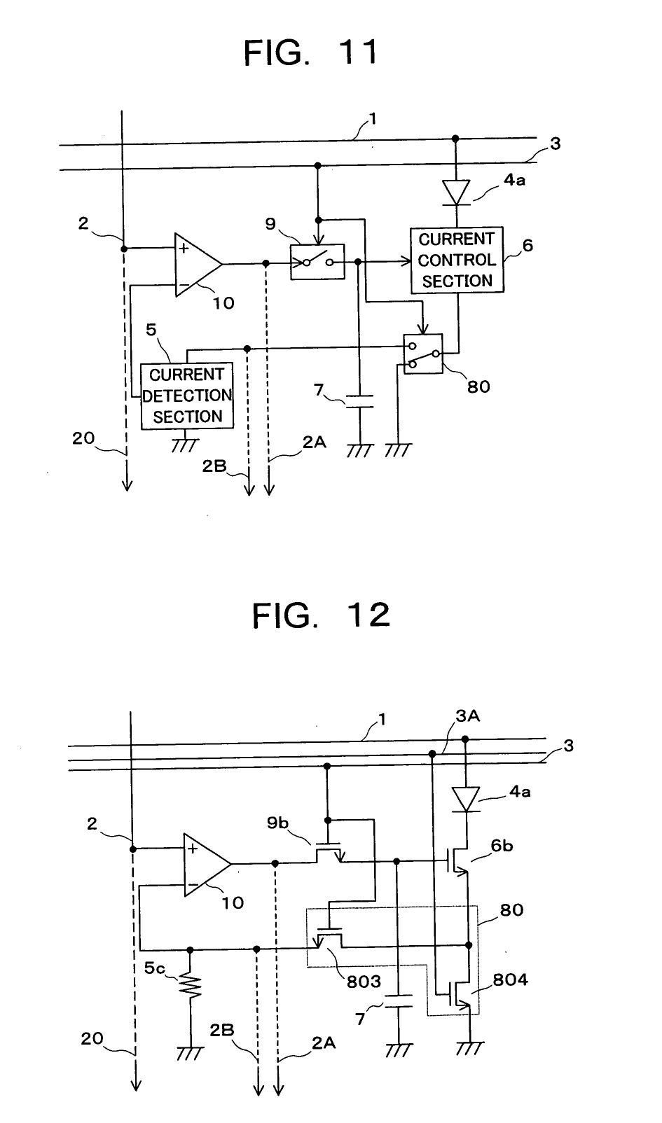

FIG. 11 is a block view showing a structure of a particular pixel in the organic EL display apparatus according to yet another embodiment of the present invention. In FIG. 11, the same reference numerals are allotted to the same component parts as those described above, and the description on them is omitted unless there is anything to add.

In this embodiment, the first switching section 80 which operates in nearly the same way as the first switching section 8 shown in FIG. 4 is used instead of the first switching section 8. In this respect, this embodiment is an application of the modification to the embodiment shown in FIG. 4, such as the embodiment shown in FIG. 9 with respect to the embodiment shown in FIG. 1. In this embodiment, however, the current control section 6 is connected to the ground at one switching position of the first switching section 80 in view of the direction of the current. Thus, it has as an effect the items described in the embodiment shown in FIG. 4 and also has the effects particular to the embodiment shown in FIG. 9.

FIG. 12 is a circuit diagram showing an example of applying a specific element to the individual blocks in the embodiment shown as the block view in FIG. 11. In FIG. 12, the same reference numerals are allotted to the same component parts as those of FIG. 11, and the description on them is omitted. As shown in FIG. 10, a switch circuit comprising two n channel transistors 803, 804 is used as the first switching section 80. The n channel transistor 803 has quite the same connection and functions as the n channel transistor 8b shown in FIG. 5.

The n channel transistor 804 has a source connected to the ground, a drain connected to the source of the n channel transistor 6b as the current control section, and a gate connected to the second scanning line 3A having a polarity opposite to that of the scanning line 3. By configuring in this way, one of the transistor 803 and the transistor 804 is turned on and the other is turned off by the scanning signal (pixel selection signal) supplied to the scanning lines 3, 3A, so that the functions of the first switching section 80 shown in FIG. 11 are realized.

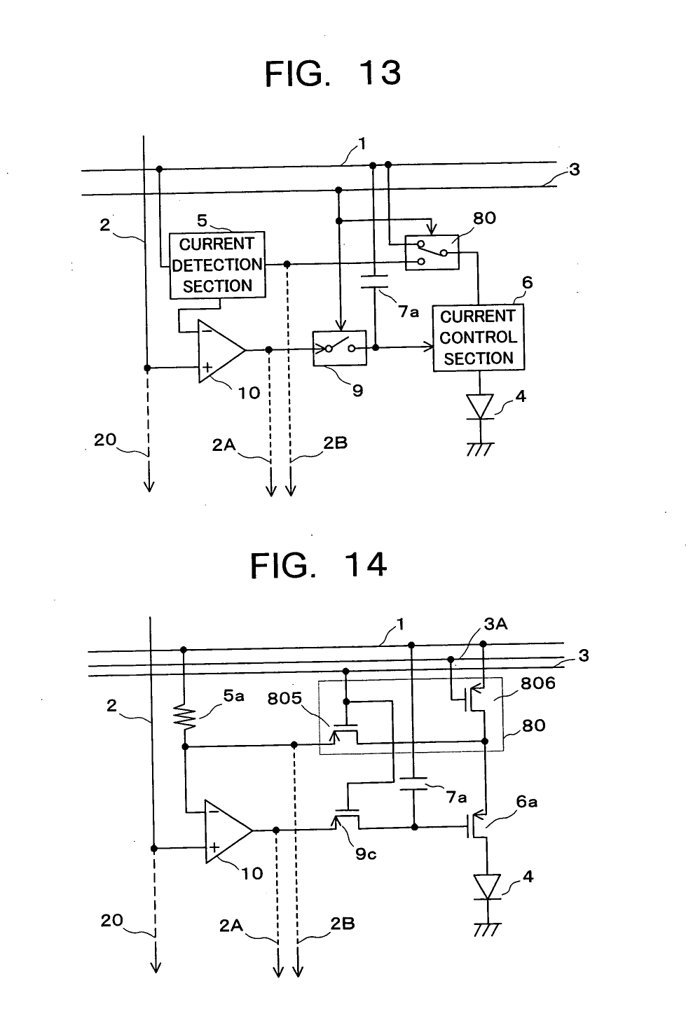

FIG. 13 is a block view showing a structure of a particular pixel in the organic EL display apparatus according to yet another embodiment of the present invention. In FIG. 13, the same reference numerals are allotted to the same component parts as those described above, and the description on them is omitted. This embodiment is an application of the modification to the embodiment shown in FIG. 6, such as the embodiment shown in FIG. 9 with respect to the embodiment shown in FIG. 1. The operation and effects are obvious from the already described embodiments, so that the description on them is omitted.

FIG. 14 is a circuit diagram showing an example of applying a specific element to the individual blocks in the embodiment shown as the block view in FIG. 13. In FIG. 14, the same reference numerals are allotted to the same component parts as those of FIG. 13, and the description on them is omitted. As shown in FIG. 14, a switch circuit comprising two p channel transistors 805, 806 is used as the first switching section 80. The p channel transistor 805 has quite the same connection and functions as those of the p channel transistor 8c shown in FIG. 7

The p channel transistor 806 has a source connected to the power line 1, a drain connected to the source of the n channel transistor 6a as the current control section, and a gate connected to the second scanning line 3A having a polarity opposite to that of the scanning line 3. By configuring in this way, one of the transistor 805 and the transistor 806 is turned on and the other is turned off by the scanning signal (pixel selection signal) supplied to the scanning lines 3, 3A, so that the functions of the first switching section 80 shown in FIG. 13 can be realized.

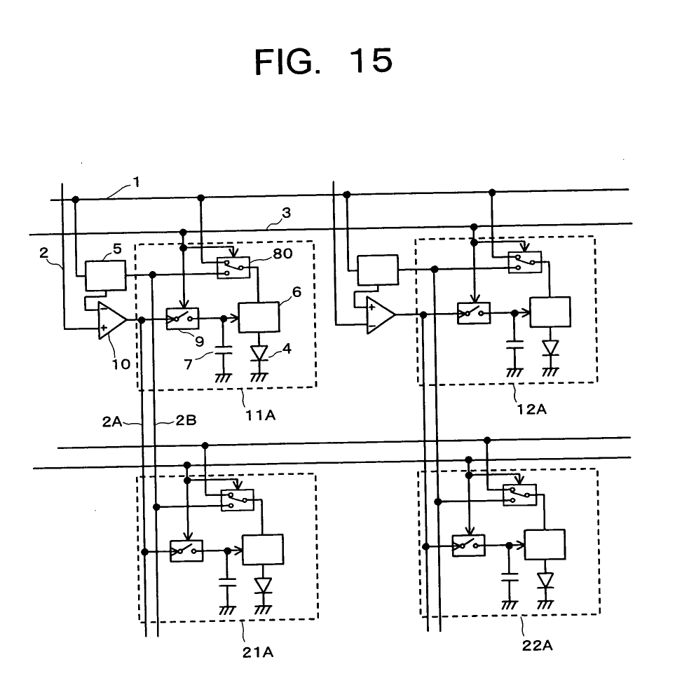

FIG. 15 is a view showing the connection between the power line 1, the image signal line 2 and the scanning line 3 and the individual pixels with the pixels having the structure shown in FIG. 9 used and disposed longitudinally and latitudinally. In FIG. 15, the same reference numerals are allotted to the same component parts as those described above. As shown in FIG. 15, pixels 11A, 12A, . . . are disposed in a latitudinal (row) direction, and the pixels 11A, 21A, . . . are disposed in a longitudinal (column) direction so that the pixels are arranged in a matrix form as a whole. It is easily apparent from the drawing that the current detection section 5 and the comparison amplifying section 10 are not required for each of the pixels in the same manner as in the embodiment shown in FIG. 8.

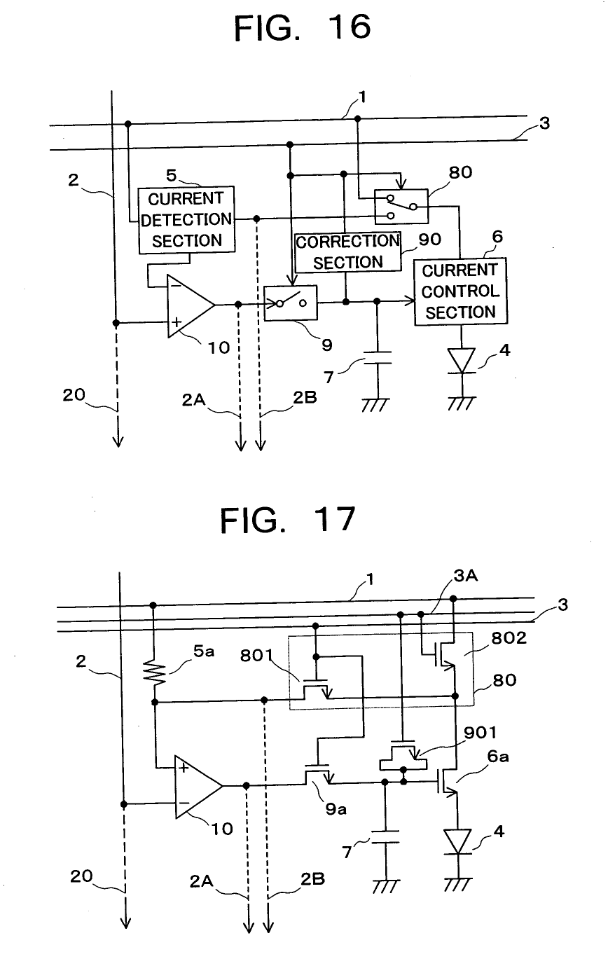

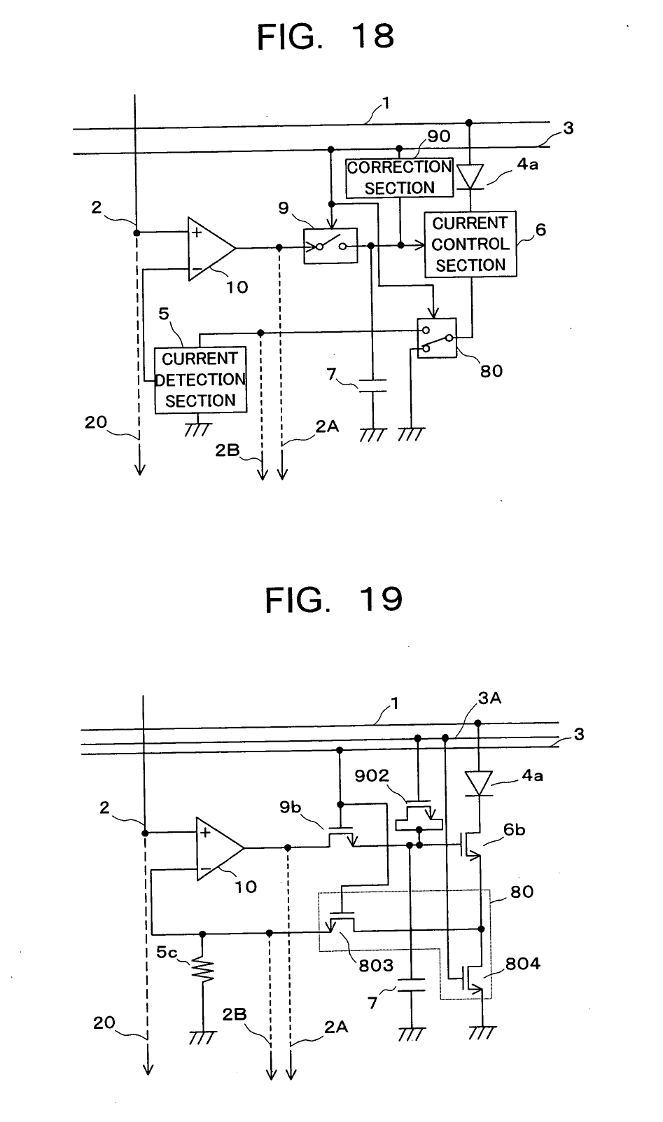

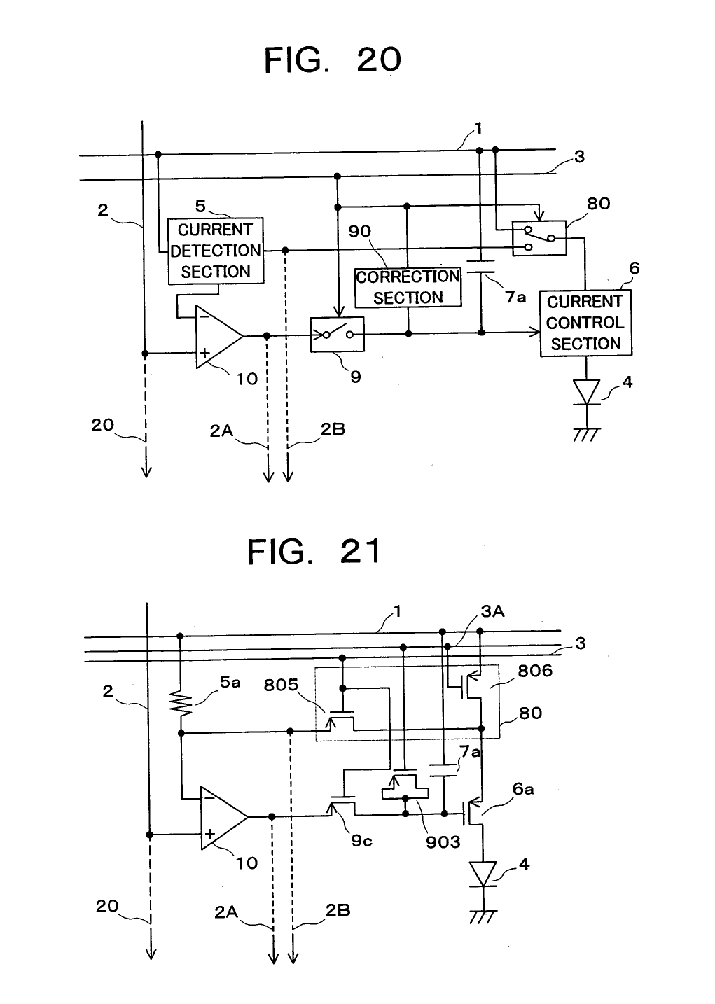

FIG. 16, FIG. 18 and FIG. 20 each are block views showing a structure of a particular pixel in the organic EL display apparatus according to yet another embodiment of the present invention, and FIG. 17, FIG. 19 and FIG. 21 each are circuit diagrams showing an example of applying a specific element to the individual blocks in the embodiments shown as the block views in FIG. 16, FIG. 18 and FIG. 20. In these drawings, the same reference numerals are allotted to the corresponding component parts as those described above, and the description on them is omitted.

The embodiments shown in FIG. 16 through FIG. 21 are modifications of the embodiments shown in FIG. 9 through FIG. 14. FIG. 16 corresponds to FIG. 9, FIG. 17 corresponds to FIG. 10, . . . , and FIG. 21 corresponds to FIG. 14.

As shown in FIG. 16, FIG. 18 and FIG. 20, a correction section 90 is additionally incorporated and inserted and connected between the scanning line 3 and the control input terminal of the current control section 6. It is added in order to prevent noise from occurring in the control input terminal of the current control section 6 at the time of the switching operation of the second switching section 9. A reason of noise caused in the voltage of the control input terminal of the current control section 6 by the switching operation of the second switching section 9 is considered that a change in the voltage of the scanning line 3 is transmitted to the current control section 6 side (its control input terminal side) of the second switching section 9 by a parasitic capacitance or the like.

Accordingly, the correction section 90 is disposed to configure such that a change in voltage of the scanning line 3 can be transmitted as intended in a reverse polarity to the side of the control input terminal of the current control section 6. Thus, the produced noise can be cancelled.

As shown in FIG. 17, FIG. 19 and FIG. 21, as a specific example of the correction section 90, the gate and the source-drain common connection terminal of the n channel transistors 901, 902 or the p channel transistor 903 can be used. These gates are connected to the second scanning line 3A having a polarity opposite to that of the scanning line 3.

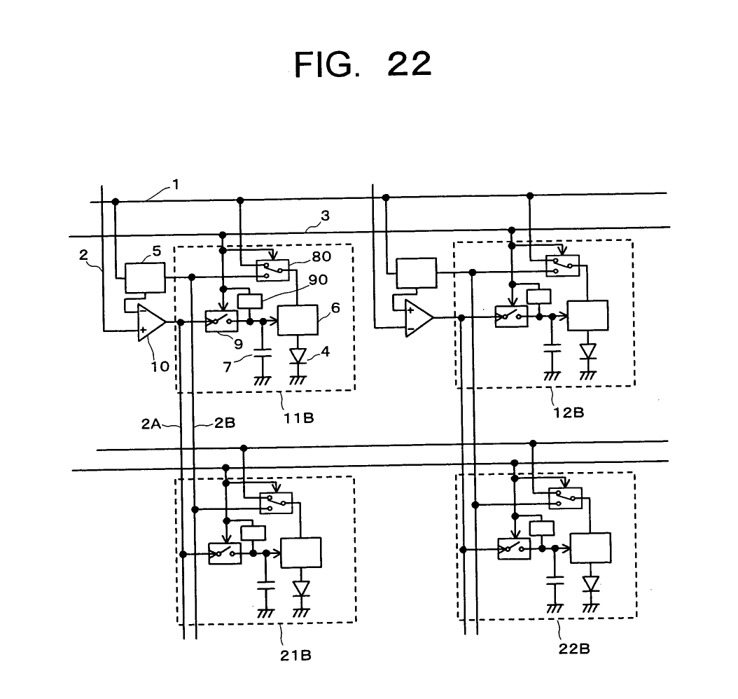

FIG. 22 is a view showing the connection between the power line 1, the image signal line 2 and the scanning line 3 and the individual pixels with the pixels having the structure shown in FIG. 16 used and disposed longitudinally and latitudinally. In FIG. 22, the same reference numerals are allotted to the same component parts as those described above. As shown in FIG. 22, pixels 11B, 12B, . . . are disposed in a latitudinal (row) direction and the pixels 11B, 21B, . . . are disposed in a longitudinal (column) direction so that the pixels are arranged in a matrix form as a whole. It is easily apparent from the drawing that the current detection section 5 and the comparison amplifying section 10 are not required for each of the pixels in the same manner as in the embodiments shown in FIG. 8 and FIG. 15.

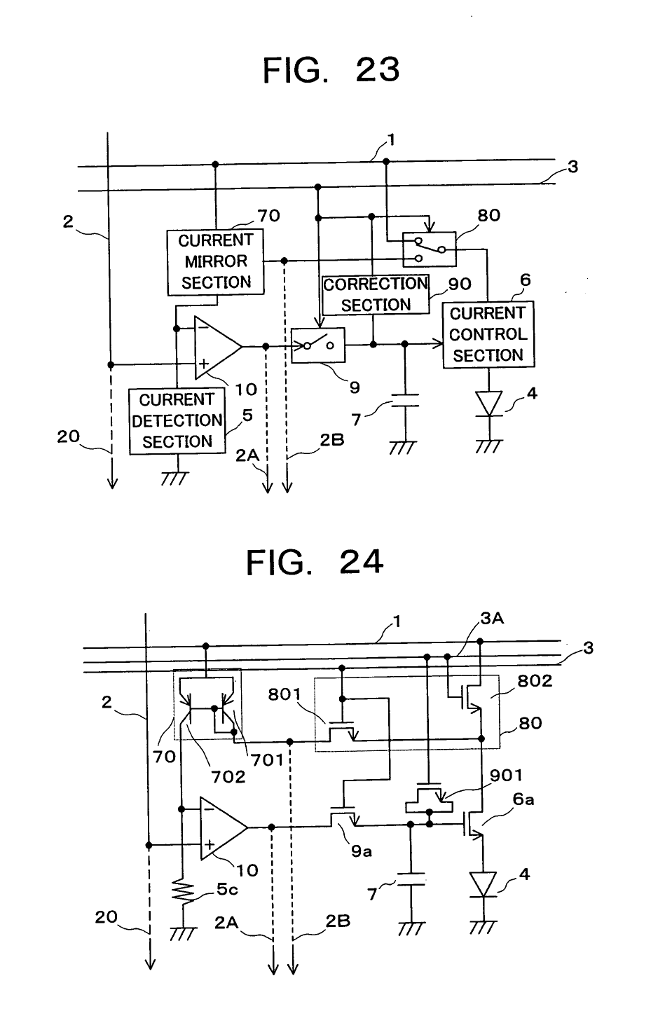

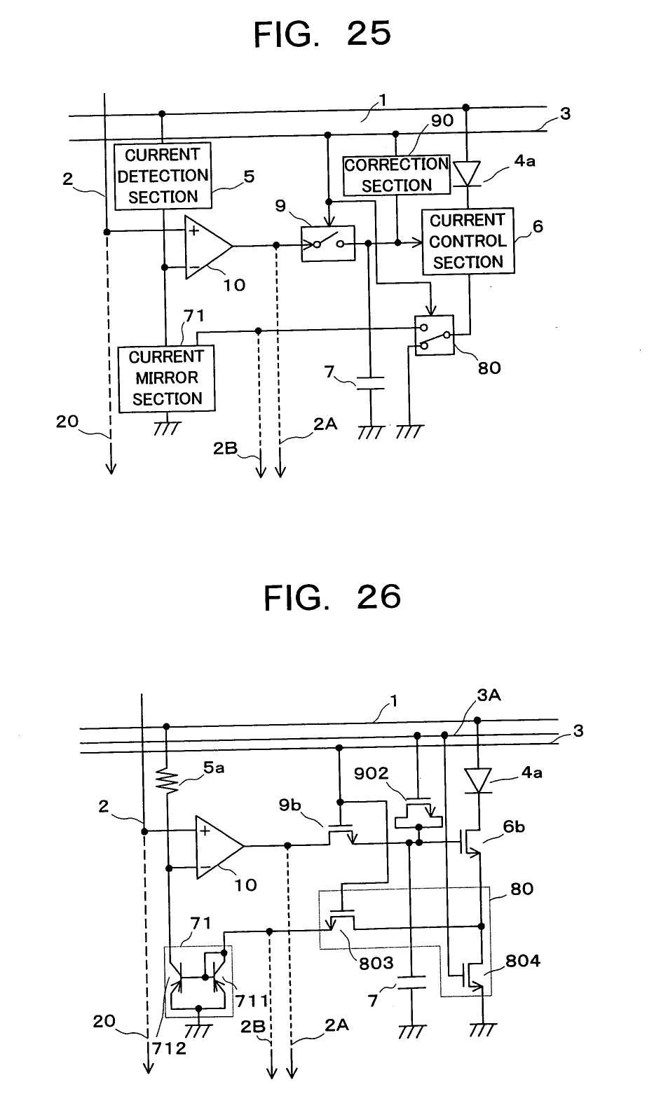

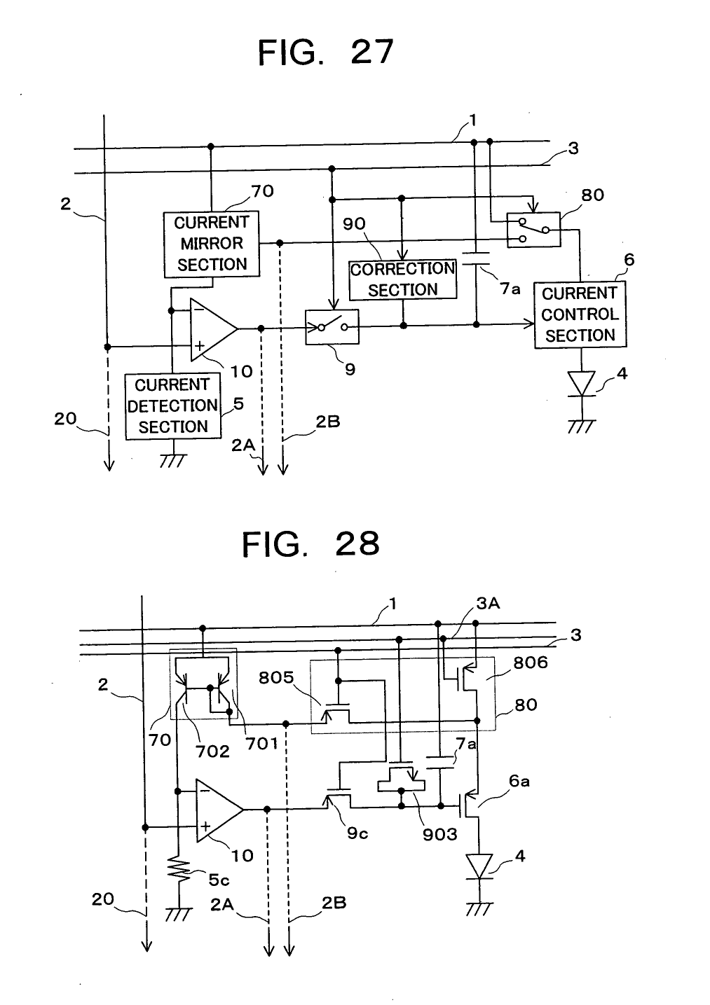

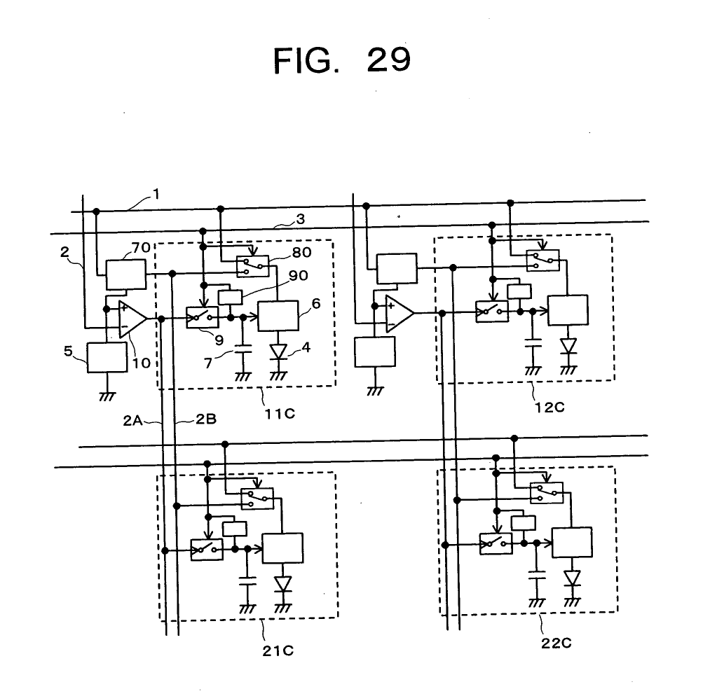

FIG. 23, FIG. 25 and FIG. 27 each are block views showing a structure of a particular pixel in the organic EL display apparatus according to yet another embodiment of the present invention, and FIG. 24, FIG. 26 and FIG. 28 each are circuit diagrams showing an example of applying a specific element to the individual blocks in the embodiments shown as the block views in FIG. 23, FIG. 25 and FIG. 27. In these drawings, the same reference numerals are allotted to the same component parts as those described above, and the description on them is omitted.

The embodiments shown in FIG. 23 through FIG. 28 each are additional modifications of the embodiments shown in FIG. 16 through FIG. 21. FIG. 23 corresponds to FIG. 16, FIG. 24 corresponds to FIG. 17, . . . , and FIG. 28 corresponds to FIG. 21.

As shown in FIG. 23, FIG. 25 and FIG. 27, a current mirror section 70 (or 71) is additionally incorporated for insertion and connection between the first switching section 80 and the current detection section 5. It is added in order to avoid an arrangement to position the current detection section 5 directly on the output side of the first switching section 80 so as to prevent the frequency characteristic from degrading at the pertinent position.

As apparent from the drawings, the wiring corresponding to reference numeral 2B is connected from the individual pixels and becomes long, so that the wiring capacity of this node has a possibility of becoming large to some extent. Here, when the current detection section 5 formed of, for example, a resistor is directly disposed, a delay occurs depending on a CR product. Accordingly, such a delay can be prevented by outputting the current to the current detection section 5 via the current mirror section 70 (or 71).

As shown in FIG. 24, FIG. 26 and FIG. 28, as a specific example of the current mirror section 70 (or 71), base and emitter common connection circuits of pnp transistors 701, 702 or npn transistors 711, 712 can be used. Here, the transistors 701, 711 on the side of the first switching section 80 are operated as diode with the base and collector possessed commonly. By connecting in this way, a current substantially equal to the output current from the first switching section 80 is made to flow to the resistor 5c (or 5a) according to a characteristic that the collector current becomes equal between the two transistors 701, 702 (or 711, 712) which are made to have the same voltage between the base and the emitter.

FIG. 29 is a view showing the connection between the power line 1, the image signal line 2 and the scanning line 3 and the individual pixels with the pixels having the structure shown in FIG. 23 used and disposed longitudinally and latitudinally. In FIG. 29, the same reference numerals are allotted to the same component parts as those described above. As shown in FIG. 29, pixels 11C, 12C, . . . are disposed in a latitudinal (row) direction and the pixels 11C, 21C, . . . are disposed in a longitudinal (column) direction so that the pixels are arranged in a matrix form as a whole. It is easily apparent from the drawing that the current detection section 5 and the comparison amplifying section 10 are not required for each of the pixels in the same manner as in the embodiments shown in FIG. 8, FIG. 15 and FIG. 22. The same is also applied to the current mirror section 70.

It is to be understood that the present invention is not limited to the specific embodiments thereof illustrated herein, and all the changes which come within the meaning and range of equivalency of the claims are therefore intended to be embraced therein.

1. An organic EL display apparatus which has plural pixels arranged in a matrix form, selects pixels from the plural pixels according to a pixel selection signal and causes the selected pixels to emit light according to an image signal, comprising:
a light emitting section;
a current control section which controls a current to be flown to the light emitting section;
a first switching section which switches, according to the pixel selection signal, between transmission and non-transmission of the current controlled by the current control section;
a current detection section which detects as a voltage a value of the controlled current transmitted by the first switching section;
a comparison amplifying section which performs comparison and amplification of a value of the voltage corresponding to the detected current and a voltage value corresponding to the image signal;
a second switching section which switches, according to the pixel selection signal, between transmission and non-transmission of a voltage value resulting from the comparison and amplification; and
an image signal holding capacitor which is charged or discharged according to a voltage value transmitted from the second switching section,
wherein the current control section controls the current to be flown to the light emitting section according to a charging voltage of the image signal holding capacitor.

2. An organic EL display apparatus as set forth in claim 1,
wherein the current detection section is a resistor or a Hall element which is inserted and connected between a power source and the first switching section; and
wherein the light emitting section is inserted and connected between the current control section and a ground.

3. An organic EL display apparatus as set forth in claim 1, wherein the current detection section uses an on resistance of a thin film transistor which is inserted and connected between a power source and the first switching section to detect the controlled current value as a voltage.

4. An organic EL display apparatus as set forth in claim 1,
wherein the current detection section is a resistor or a Hall element which is inserted and connected between a ground and the first switching section; and
wherein the light emitting section is inserted and connected between the current control section and a power source.

5. An organic EL display apparatus as set forth in claim 1,
wherein the light emitting section, the current control section, the first switching section, the second switching section and the image signal holding capacitor are disposed on each of the plural pixels;
wherein the comparison amplifying section and the current detection section are disposed as one set on each column of the pixels in the matrix form;
wherein connection from the first switching section to the current detection section is made by all pixels contained in the column of pixels to which the current detection section belongs; and
wherein connection from the comparison amplifying section to the second switching section is made on all the pixels contained in the column of pixels to which the comparison amplifying section belongs.

6. An organic EL display apparatus as set forth in claim 2, wherein the current control section is an n channel thin-film transistor and outputs the current to be flown to the light emitting section as a drain-source current, and the current is controlled by the charging voltage of the image signal holding capacitor supplied to a gate.

7. An organic EL display apparatus as set forth in claim 2, wherein the current control section is a p channel thin-film transistor and outputs the current to be flown to the light emitting section as a source-drain current, and the current is controlled by the charging voltage of the image signal holding capacitor supplied to a gate.

8. An organic EL display apparatus as set forth in claim 4, wherein the current control section is an n channel thin-film transistor and outputs the current to be flown to the light emitting section as a drain-source current, and the current is controlled by the charging voltage of the image signal holding capacitor supplied to a gate.

9. An organic EL display apparatus as set forth in claim 1, wherein the current control section is an amorphous silicon transistor.

10. An organic EL display apparatus as set forth in claim 1, wherein, when the first switching section determines the current controlled by the current control section to be non-transmissive, the first switching section makes the current flow to a power source or a ground.

11. An organic EL display apparatus as set forth in claim 10, wherein, as an element which flows the current controlled by the current control section to the power source or the ground when the first switching section determines to be non-transmissive, the first switching section has a transistor having a gate to which a second pixel selection signal having a polarity opposite to that of the image selection signal is supplied.

12. An organic EL display apparatus as set forth in claim 1, further comprising a correction section which is disposed in connection with an output side of the second switching section and removes noise produced by the second switching section.

13. An organic EL display apparatus as set forth in claim 12, wherein the correction section is a two-terminal element which is comprised of a source-drain common connection terminal and a gate terminal, one of them is connected to the output side of the second switching section and the other is a terminal to which a second pixel selection signal having a polarity opposite to that of the pixel selection signal can be supplied.

14. An organic EL display apparatus as set forth in claim 1, further comprising a current mirror section which is driven by the controlled current transmitted by the first switching section and outputs a current whose value is substantially the same as that of the controlled current,
wherein the current detection section detects as a voltage a value of the current output by the current mirror section.
